(19) United States
(12) Patent Application Publication
(10) Pub. No.: US 2002/0118910 A1
(43) Pub. Date: Aug. 29, 2002

(54) Light deflector and method for driving light deflector

(76) Inventors: Mikio Okumura, Yokohama-shi (JP); Yasuhiro Sugeno, Yokohama-shi (JP); Terunobu So, Yokohama-shi (JP); Takayuki Iseki, Yokohama-shi (JP)

Correspondence Address: Morris Liss, Connolly Bove Lodge & Hutz LLP, Suite 800, 1990 M Street, N.W., Washington, DC, 20036-3425, US

(21) Appl. No.: 10/074,226

(22) Filed: Feb. 14, 2002

(30) Foreign Application Priority Data
Dec. 7, 2001 (JP) 2001-373820
Feb. 14, 2001 (JP) 2001-036638

(51) Int. Cl. G02B 6/35; G02B 7/182

(52) U.S. Cl. 385/18; 359/872

(57) ABSTRACT

A light deflector for deflecting light inputted through an optical fiber to switch a plurality of cross-connected optical fibers for optical communication. The light deflector is composed of a mirror for deflecting the inputted light, a supporting member for connecting with the mirror by at least one edge thereof, and a frame portion for holding the other edge of the supporting member. The supporting member is composed of a driving member incorporated thereof for transforming convex-concave by supplying an impressed voltage of zero and over values having inverted polarity in relation to initial condition, to make the mirror incline to desirable direction.

### BACKGROUND OF THE INVENTION

1. Field of the Invention

The present invention relates to a light deflector for switching a light path of plurality of an optical fiber cross-connected and used in optical information communication filed, and a method for driving the light deflector for deflecting light by sloping a mirror incorporated in the light deflector.

2. Description of the Related Art

A light deflector used in optical information communication field is switching a light path from a plurality of cross-connected optical fiber, and is set in array with the same number of the optical fiber being cross-connected.

The light deflector requires to be compact, and to provide greater deflection angle with fast switching operation. The light deflector of such a kind is disclosed in Japanese Patent Application Laid-open No. 8-320441/1996 as a mirror deflector.

FIG. 18 shows a mirror deflector in accordance with the related art. In FIG. 18, the mirror deflector is composed of a mirror portion 91, a piezoelectric device 92 for making deflection of the mirror portion 91, and a fixed plate 93 for fixing the other side of piezoelectric device 92.

The piezoelectric device 91 is composed of four piezoelectric devices 92a through 92d each of which is having the same length and shape. Two sides of the piezoelectric device, which are parallel to the direction of expansion and contraction, are connected with the sides of the other piezoelectric device to form a loop. The piezoelectric devices 92a through 92d are forming in a columnar shape.

The mirror deflector operates as follows. The mirror portion 91 declines to the direction of θ when making an impressed voltage for the piezoelectric devices 92a and 92b bigger than that of the piezoelectric devices 92c and 92d. The mirror portion 91 declines to the direction of ψ when making an impressed voltage for the piezoelectric devices 92a and 92d bigger than that of the piezoelectric devices 92b and 92c. The mirror portion 91 can deflect to either direction of θ and ψ by controlling the impressed voltage for the piezoelectric devices 92a through 92d.

The mirror deflector described above has a driving point at the center of the mirror 91 that the deflection angle of the mirror 91 can be bigger and the driving operation of the deflection of the mirror can be faster.

However, the mirror deflector is a light deflector with bulk type that it is difficult to make it compact in size and to place it in matrix array.

### SUMMARY OF THE INVENTION

Accordingly, in consideration of the above-mentioned problems of the related art, an object of the present invention is to provide a light deflector for deflecting light to switch a plurality of cross-connected optical fibers for optical communication, including, a mirror for deflecting light input through the plurality of cross-connected optical fibers by sloping at the center thereof, a supporting member for holding the mirror in the same plane wherein the supporting member is being connected with the mirror at least one edge thereof, a frame portion for holding another edge of the supporting member, and a driving member incorporated in the supporting member for inclining the supporting member by transforming convex-concave to make the mirror sloping to desirable direction.

Other object and further features of the present invention will be apparent from the following detailed description when lead-in conjunction with the accompanying drawings.

### BRIEF DESCRIPTION OF DRAWINGS

FIG. 1 is a perspective view of a light deflector according to a first embodiment of the present invention.

FIG. 2 is a diagram for explaining the structure of a driving member of the light deflector shown in FIG. 1.

FIG. 3 shows a projection area of the light deflected by the light deflector shown in FIG. 1.

FIG. 4 is a table showing a driving status of the driving members 5a through 5d shown in FIG. 1.

FIGS. 5(a) through 5(d) are perspective view of the light deflector shown in FIG. 1 in various transformations.

FIG. 6 is a light deflector in accordance with a second embodiment of the present invention.

FIG. 7 is a table showing a driving status of driving members 13a, 13b, 14a and 14b shown in FIG. 6.

FIGS. 8(a) through 8(d) are perspective view of the light deflector shown in FIG. 6 in accordance with the driving status shown in FIG. 7.

FIG. 9 shows a perspective view of a light deflector according to a third embodiment of the present invention.

FIG. 10 is a table showing the status of driving members 25 through 28 shown in FIG. 9 when a light is deflected to each point shown in FIG. 3.

FIGS. 11(a) through 11(d) are perspective view of the light deflector shown in FIG. 9 showing the status of mirror sloping upon the deflection of light.

FIG. 12 shows a perspective view of a light deflector in accordance with a fourth embodiment of the present invention.

FIG. 13 is a table showing a driving status of driving members 35a through 35d and 36a through 36d shown in FIG. 12.

FIGS. 14(a) through 14(d) are perspective view of the light deflector shown in FIG. 12 showing the status of mirror sloping upon the deflection of light.

FIG. 15 is a perspective view of a light deflector 40 in accordance with a fifth embodiment of the present invention.

FIG. 16 is a table showing a driving status of driving members 45a, 45b, 46a, 46b, 47a, 47b, 48a and 48b shown in FIG. 15.

FIG. 17(a) through 17(d) are perspective view of the light deflector 40 shown in FIG. 15 in accordance with the driving status shown in FIG. 16.

FIG. 18 shows a mirror deflector in accordance with the related art.

### DETAILED DESCRIPTION OF THE PREFERRED EMBODIMENTS

[First Embodiment]

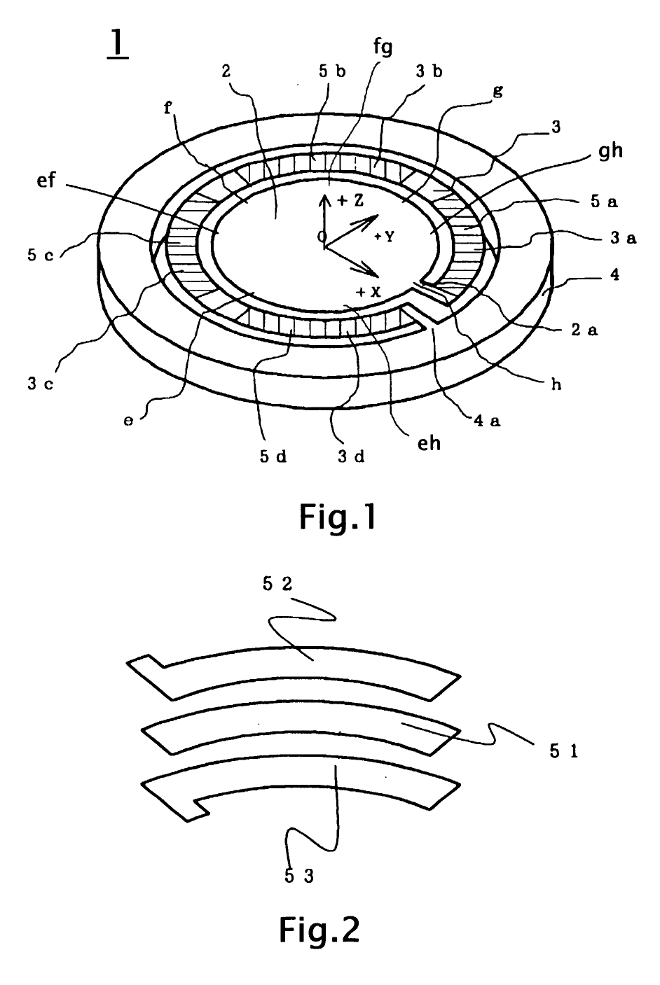

FIG. 1 is a perspective view of a light deflector according to a first embodiment of the present invention. In FIG. 1, a light deflector 1 is composed of a mirror 2 in a circle shape, a supporting member 3 in a thin plate shape and a frame portion 4. The supporting member 3 and the mirror 2 are in the same plane. The supporting member 3 is placed in the outer circumference around the mirror 2 (in every 360 degrees). One end of the supporting member 3 is connected with an outer frame 2a of the mirror 2 to hold the same, and the other end is connected with a connecting portion 4a of the frame portion 4.

Assuming that the line crossing the center “0” of the mirror 2 and the outer frame 2a is X axis, and the line crossing the center “0” and orthogonal to the X axis is Y axis, the surface of the mirror 2 can be divided into quadrant. A first quadrant of the surface of the mirror 2 corresponds to an area 3a of the supporting member 3 and has a driving member 5a. A second quadrant of the surface of the mirror 2 corresponds to an area 3b of the supporting member 3 and has a driving member 5b. A third quadrant of the surface of the mirror 2 corresponds to an area 3c of the supporting member 3 and has a driving member 5c. A fourth quadrant of the surface of the mirror 2 corresponds to an area 3d of the supporting member 3 and has a driving member 5d.

Each point of “e”, “f”, “g” and “h” in FIG. 1 represents the edge portion of the mirror 2 that the point “e” is in the direction of the −Y-axis, the point “f” is in the direction of the −X-axis, the point “g” is in the direction of the +Y-axis and the point “h” is in the direction of the +X-axis of the mirror 2. Further, a point of “ef” represents the midpoint of “e” and “f”, a point of “fg” represents the midpoint of “f” and “g”, a point of “gh” represents the midpoint of “g” and “g”, and a point of “eh” represents the midpoint of “h” and “e”.

FIG. 2 is a diagram for explaining the structure of a driving member of the light deflector shown in FIG. 1. In FIG. 2, all of the driving members 5a through 5d are in the same structure that a piezoelectric film 51 has electric poles 52 and 53 in the front surface and the rear surface of the film. The driving members 5a through 5d provide transforming characteristic that they deform roughly to the direction of Z axis shown in FIG. 1 which is orthogonal to the X and Y axes. A wire for providing a control voltage to the driving members 5a through 5d is not shown but is placed along the surface of the supporting member 3.

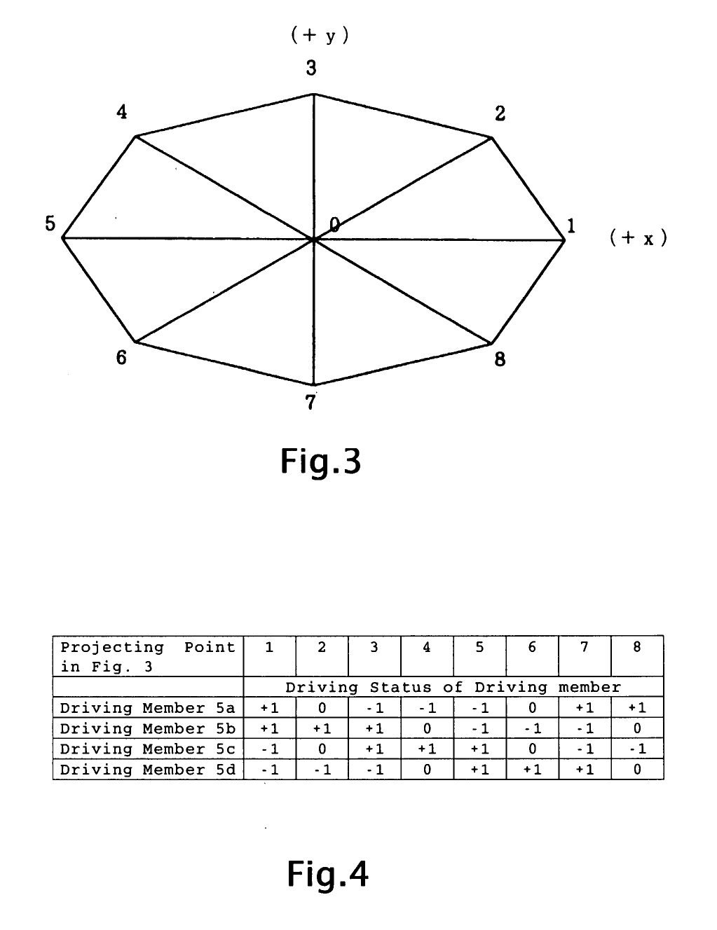

FIG. 3 shows a projection area of the light deflected by the light deflector shown in FIG. 1. In FIG. 3, a line 0-1 or 0-5 represents the X-axis and a point “1” indicates +X direction. Similarly, a line 0-3 or 0-7 represents the Y-axis and a point “3” indicates +Y direction. The X and Y axes shown in FIG. 3 correspond to the X and Y axes shown in FIG. 1.

FIG. 4 is a table showing a driving status of the driving members 5a through 5d shown in FIG. 1. In FIG. 4, the indication of +1 represents that a positive impressed voltage has been supplied to the driving member and that the piezoelectric film 51 has been transformed maximally. The driving members 5a through 5d on the surface of the supporting member 3 can be in a driving state of transformation that its front surface becomes convex and its rear surface becomes concave, like a bimetal material. The indication of −1 represents that a negative impressed voltage has been supplied to the driving member and that the piezoelectric film 51 has been transformed minimally. The driving members 5a through 5d on the surface of the supporting member 3 can be in a driving state of transformation that its front surface becomes concave and its rear surface becomes convex. Further, the indication of “0” represents that the piezoelectric film 51 remains as an initial condition and does not transform.

First embodiment of the present invention provides the light deflector 1 having four driving members 5a through 5d on the surface of the supporting member 3 which are controlled by certain rules to make a desirable slope axis and to make light deflection to a desirable direction.

In case of this embodiment, the slope of the mirror 2 is provided by transformation and torsion of the piezoelectric film 51 for each driving member 5a through 5d of the supporting member 3. The torsion can be provided by placing the supporting member 3 on the outer circumference of the mirror 2 and eventually the supporting member 3 provides three dimensional transformation. This torsion of transformation is considered to be a great factor of making slope of the mirror 2 to desirable direction.

The transformation described above can be confirmed by piezoelectric-structural analysis using, for example, software of ANSYS Multi Physics (developed by ANSYS Inc.) The operation of the first embodiment can be explained by the relation between the simulation of the driving state for the driving members 5a through 5d, and the slope of the mirror 2.

In case that the light is deflected from the point “0” to the point “1” shown in FIG. 3, the driving state of the driving members 5a and 5b are +1 (that is expansion), the driving state of the driving members 5c and 5d are −1 (that is contraction). The areas 3a and 3b corresponding to the driving members 5a and 5b transform by its front surface becoming convex and its rear surface becoming concave. The areas 3c and 3d corresponding to the driving members 5c and 5d transform by its front surface becoming concave and its rear surface becoming convex.

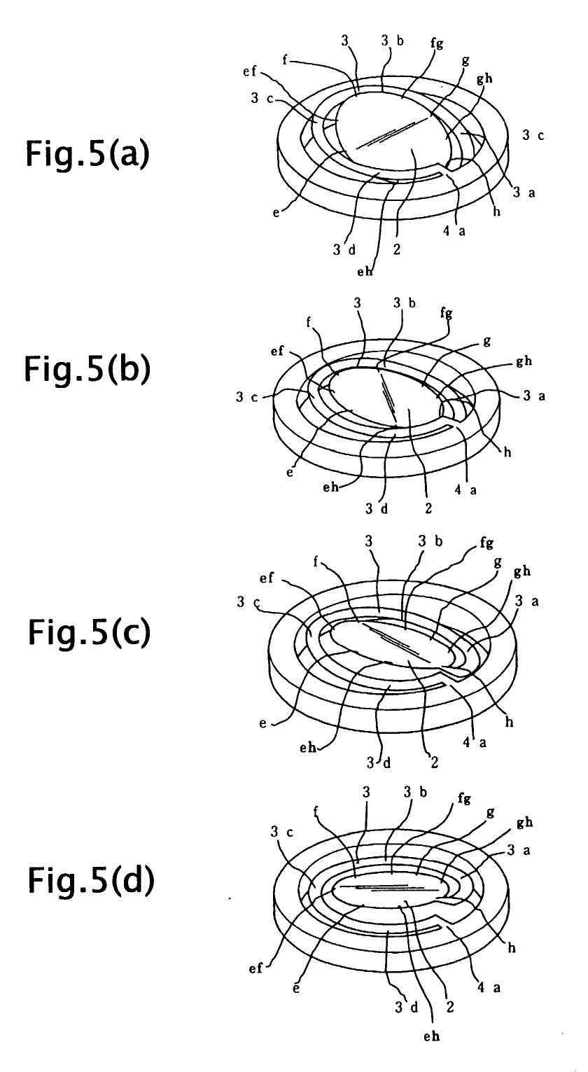

FIGS. 5(a) through 5(d) are perspective view of the light deflector according to the present invention in various transformation. In FIG. 5(a), the point “f” of the mirror 2 is in the highest position and the point “h” of the mirror 2 is in the lowest position. The mirror 2 rotates at the center on the Y-axis shown in FIG. 1, and slopes the reflection side to the direction of +Y-axis. Eventually, the reflection light from the mirror 2 deflects to the point “1” shown in FIG. 3.

In case that the light is deflected from the point “0” to the point “2” shown in FIG. 3, the driving state for the driving member 5b is +1 (expansion), and the driving state for the driving member 5d is −1 (contraction). The driving state for the driving members 5a and 5c remains “0” (that is “initial condition”). The area 3b corresponding to the driving member 5b transforms by its front surface becoming convex and its rear surface becoming concave. The area 3d corresponding to the driving member 5d transforms by its front surface becoming concave and its rear surface becoming convex. The areas 3a and 3c corresponding to the driving members 5a and 5c does not transform. In FIG. 5(b), the point “ef” of the mirror 2 is in the highest position and the point “gh” of the mirror 2 is in the lowest position that the mirror 2 slopes in 45 degrees to the direction of the first quadrant thereof. Eventually, the reflection light from the mirror 2 deflects to the point “2” shown in FIG. 3.

In case that the light is deflected from the point “0” to the point “13” shown in FIG. 3, the driving state for the driving members 5b and 5c is +1 (expansion), the driving state for the driving members 5a and 5d is 1 (contraction). The areas 3b and 3c corresponding to the driving members 5b and 5c transform by its front surface becoming convex and its rear surface becoming concave. The areas 3a and 3d corresponding to the driving members 5a and 5d transform by its front surface becoming concave and its rear surface becoming convex. The transformation of the surface of the supporting member 3 as described above provides the point “e” of the mirror 2 in the highest position, and the position “g” of the mirror 2 in the lowest position. Eventually, as shown in FIG. 5(c), the mirror 2 rotates at the center on the X-axis shown in FIG. 1 and slopes to the direction of the Y-axis that the reflection light from the mirror 2 deflects to the point “3” shown in FIG. 3.

In case that the light is deflected from the point “0” to the point “4” shown in FIG. 3, the driving state for the driving members 5b and 5d remain “0” (initial condition), the driving state for the driving member 5a is −1 (contraction), and the driving state for the driving member 5c is +1 (expansion). The area 3a corresponding to the driving member 5a transforms by its front surface becoming concave and its rear surface becoming convex. The area 3c corresponding to the driving member 5c transforms by its front surface becoming convex and its rear surface becoming concave. The areas 3b and 3d corresponding to the driving members 5b and 5d do not transform. In FIG. 5(d), the point “eh” of the mirror 2 is in the highest position and the point “fg” of the mirror 2 is in the lowest position that the mirror 2 slopes in +45 degrees to the direction of the second quadrant thereof. Eventually, the reflection light from the mirror 2 deflects to the point “4” shown in FIG. 3.

The deflection of light to the point “5”, “6”, “7” and “8” shown in FIG. 3 can be obtained by invertedphase control of the slope control described for the point “1”, “2”, “3” and “4”. As described above, the driving control shown in FIG. 4 is conducted to each driving member 5a, 5b, 5c and/or 5d so that the light can be deflected to any of the eight points shown in FIG. 3. Further, if the control value of the driving members 5a through 5d is adjusted adequately, the light can be deflected on desirable point with in the projection area other than the eight particular pints shown in FIG. 3. For example, the deflection to the midpoint between the point “1” and “2” can be obtained by driving the driving member 5a for the value +0.5 and the driving member 5c for the value −0.5.

Upon the rotation of the mirror 2, the value of the impressed voltage to be supplied to the driving members 5a through 5d should be “0” or reverse in polarity or equal in absolute value. If not, the mirror 2 rotates with a translational movement to the direction of the Z-axis that the mirror 2 can not provide deflection operation at stable balance.

The light deflector 1 used in the first embodiment for analysis is having the supporting member 3 and the mirror 2 made of poly-silicon material with thickness of 15 μm. The diameter of the mirror 2 is 500 μm and the width of the supporting member 3 is 300 μm. The driving members 5a through 5d are made of lead Zirconate Titanium (so called “PZT”) piezoelectric film having the thickness of 2 μm. Supplying the impressed voltage of ±5 [V] to the light deflector 1 described above, the slope of the mirror 2 becomes +2 degrees (the light deflection angle of 8 degrees).

The first embodiment provides a 2-dimensional scanning light deflector having one supporting member 3, which holds the mirror 2. The supporting member 3 has the driving members 5a through 5d on the divided area thereof. The driving members 5a through 5d transform convex-concave to the direction of normal line of the mirror 2 (Z-axis), and the value of transformation controls the slope of the mirror 2 to a desirable direction.

The movement of the mirror 2 does not stress the mirror 2 because the mirror 2 moves along with the slope of the supporting member 3 occurred by transformation of the supporting member 3 itself. Accordingly, the plane surface of the mirror 2 is maintained and stable change of the light path can be obtained so that a highly efficient light deflector is provided.

According to an aspect of the first embodiment of the present invention, there provided the light deflector 1 having the driving members 5a through 5d on the surface of the supporting member 3. However, the driving members 5a through 5d can also be placed on the rear surface of the supporting member 3. In this case, the driving control of the driving member is conducted by opposite polarity of the control described above. The driving members 5a through 5d can be a thermal expansion type which transform by temperature control, or a shape-memory alloy type placed on either front surface or rear surface of the supporting member 3. The driving member can be any material, which transforms in convex-concave to slope the mirror, and is not limited to the material described above.

[Second Embodiment]

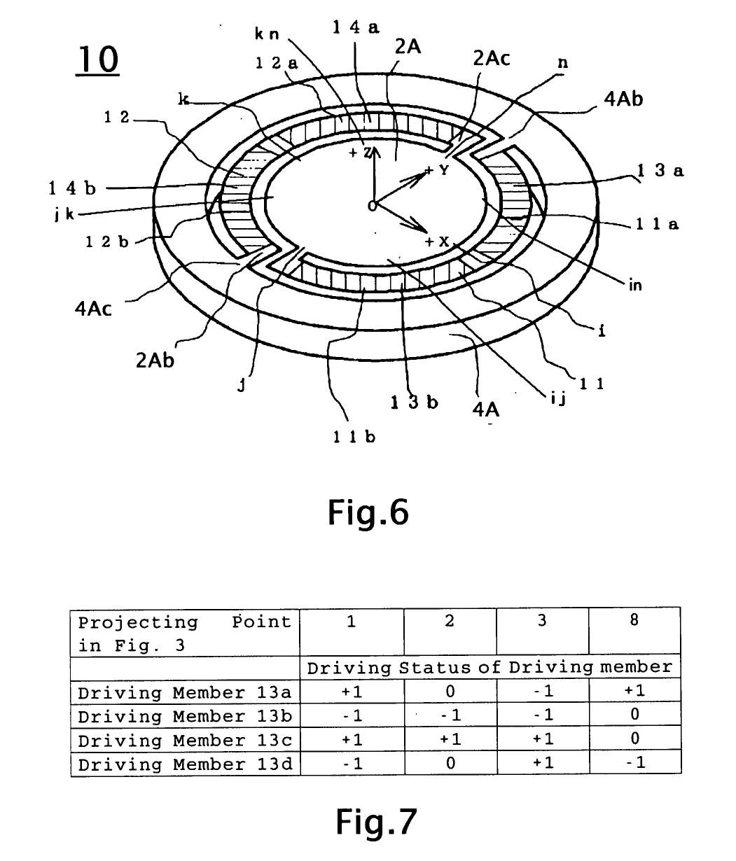

FIG. 6 is a light deflector in accordance with a second embodiment of the present invention. In FIG. 6, a light deflector 10 is composed of a mirror 2A, supporting members 11 and 12, and a frame portion 4A.

The supporting members 11 and 12 are placed in the same plane of the mirror 2A, along the outer frame of the mirror 2A oppose to each other in approx. 180 degree position. An edge of the supporting member connects with edge portions 2Ab and 2Ac of the mirror 2A to hold it and another edge connects with the connecting portion 4Ab and 4Ac.

The supporting members 11 and 12 have driving members 13a, 13b, 14a and 14b in areas 11a, 11b, 12a and 12b divided by a line crossing the edge portions 2Ab and 2Ac (i.e. the Y-axis) and a line orthogonal to the Y-axis at the center of the mirror 2A (i.e. the X-axis). Each of driving members 13a, 13b, 14a and 14b has the same structure of the driving member shown in FIG. 2.

Each point of “i”, “j”, “k” and “n” in FIG. 6 represents the edge portion of the mirror 2A that the point “i” is in the direction of +X axis, the point “j” is in the direction of −Y axis, the point “k” is in the direction of −X axis and the point “n” is in the direction of +Y axis of the mirror 2A. Further, a point of “ij” represents the midpoint of “i” and “j”, a point of “jk” represents the midpoint of “j” and “k”, a point of “kn” represents the midpoint of “k” and “n”, and a point of “in” represents the midpoint of “n” and “i”.

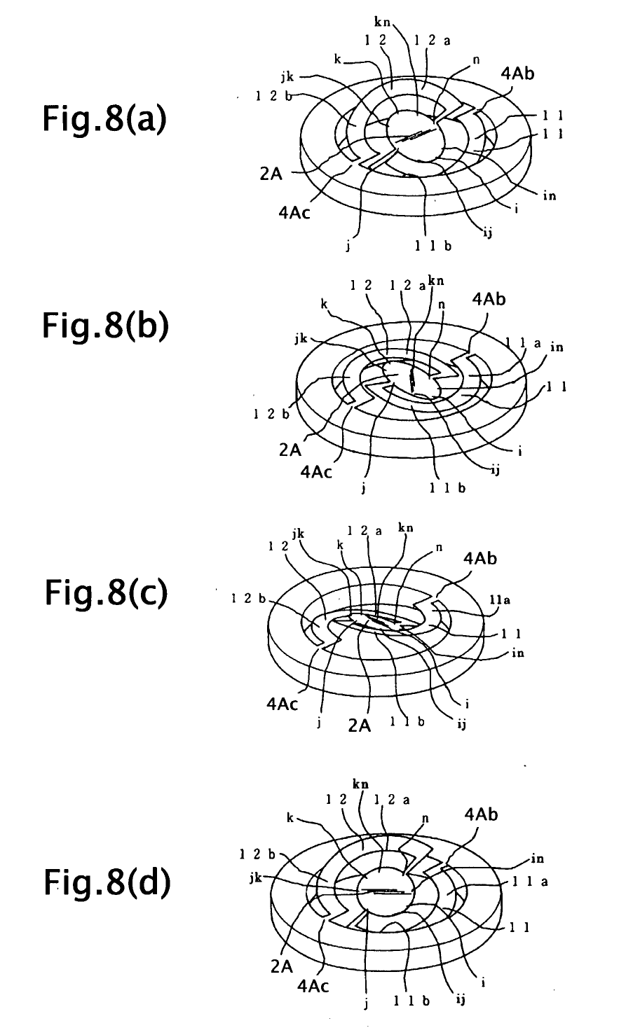

FIG. 7 is a table showing a driving status of driving members 13a, 13b, 14a and 14b shown in FIG. 6. FIGS. 8(a) through 8(d) are perspective view of the light deflector shown in FIG. 6 in accordance with the driving status shown in FIG. 7.

In FIG. 7, each driving status represents deflection of the points shown in FIG. 3. For example, the deflection to the point “1” is obtained by controlling the driving members 13a and 14a to +1 (expansion), and the driving members 13b and 14b to −1 (contraction). The supporting member 11 has an area corresponding to the driving members 13a, 13b, 14a and 14b respectively. In this case, the area 11a corresponding to the driving member 13a and the area 12a corresponding to the driving member 14a have convex front surface and concave rear surface. The area 11b corresponding to the driving member 13b and the area 12b corresponding to the driving member 14b have concave front surface and convex rear surface.

FIGS. 8(a) through 8(d) are perspective view of the light deflector in various status of deflection according to the second embodiment of the present invention. As shown in FIG. 8(a), the point “k” is in a highest position and the point “i” is in a lowest position that the mirror 2A slopes with the center of the Y-axis. Eventually, the mirror 2A deflects the light to the position “1”.

In case that the light is deflected to the point “2” shown in FIG. 3, the state of the driving members 13a and 14b remain “0” (initial condition), the state of the driving member 13b is −1 (contraction), and the state of the driving member 5c is +1 (expansion) . The area 11b corresponding to the driving member 13a transforms by its front surface becoming concave and its rear surface becoming convex. The area 12a corresponding to the driving member 14a transforms by its front surface becoming convex and its rear surface becoming concave. The areas 11a and 12b corresponding to the driving members 13a and 14b respectively will not transform. In FIG. 8(b), the point “jk” of the mirror 2A is in the highest position and the point “in” of the mirror 2A is in the lowest position that the mirror 2A slopes in −45 degrees to the direction of the first quadrant thereof. Eventually, the reflection light from the mirror 2A deflects to the point “2” shown in FIG. 3.

In case that the light is deflected to the point “3” shown in FIG. 3, the state of the driving members 13a and 13b is −1, and the driving members 14a and 14b are +1. The areas 11a and 11b corresponding to the driving member 13a and 13b transform by its front surface becoming concave and its rear surface becoming convex. The areas 12a and 12b corresponding to the driving members 14a and 14b transform by its front surface becoming convex and its rear surface becoming concave. In FIG. 8(c), the point “j” of the mirror 2A is in the highest position and the point “n”of the mirror 2A is in the lowest position that the mirror 2A slopes in the center of the X-axis to the direction of +Y axis. Eventually, the reflection light from the mirror 2A deflects to the point “3” shown in FIG. 3.

In case that the light is deflected to the point “8” shown in FIG. 3, the driving state of the driving member 13a is +1, the driving state of the driving member 14b is −1, and the driving state of the driving members 13b and 14a remain “0” (initial condition). The area 11a corresponding to the driving member 13a transforms by its front surface becoming convex and its rear surface concave. The area 12b corresponding to the driving member 14b transforms by its front surface concave and its rear surface convex. The areas 11b and 12a corresponding to the driving members 13b and 14a respectively do not transform. In FIG. 8(d), the point “kn” of the mirror 2A is in the highest position and the point “ij” of the mirror 2A is in the lowest position that the mirror 2A slopes in +45 degrees to the direction of the fourth quadrant thereof. Eventually, the reflection light from the mirror 2A deflects to the point “8” shown in FIG. 3.

The light deflection to the points other than described above is obtained by controlling the driving members 13a, 13b, 14a and 14b similarly. A further control of the driving members 13a, 13b, 14a and 14b can provide desirable deflection to the point of the projection area shown in FIG. 3.

The driving members 13a, 13b, 14a and 14b are controlled by the way as explained in the case of the driving members 5a through 5d described in the first embodiment.

As described above, the light deflector 10 for the second embodiment is composed of the supporting members 11 and 12 along the circumference of the mirror 2A in straight angle (180°) to hold the mirror 2A. The supporting members 11 and 12 are further composed of driving members 13a, 13b, 14a and 14b in the predetermined divided areas respectively. The driving members 13a, 13b, 14a and 14b are composed of piezoelectric material that they transform convex-concave by voltage control. As described in the first embodiment, the driving member is not limited to the material described in this embodiment but it can also be any material, which transforms to slope the mirror.

[Third embodiment]

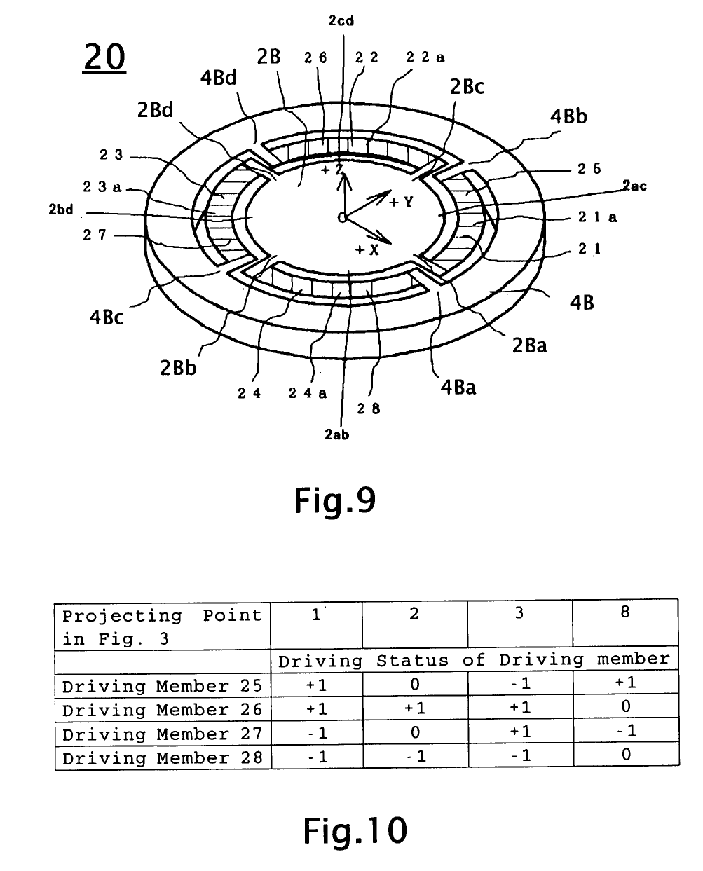

FIG. 9 shows a perspective view of the third embodiment of the present invention. A light deflector 20 is composed of four supporting members 21 through 24 to hold a discoid mirror 2B, and a frame portion 4B. The supporting members 21 through 24 are placed in the same plane of the mirror 2B in every 90 degrees angle along the circumference of the mirror 2B. The supporting members 21 through 24 are connected with an edge portion 2Ba, 2Bb, 2Bc and 2Bd to hold the mirror 2B and also connected with an edge portion of connecting portions 4Ba, 4Bb, 4Bc and 4Bd.

The supporting members 21 through 24 are composed of driving members 25 through 28 for area surfaces 21a, 22a, 23a and 24a respectively. The driving members 25 through 28 have the same construction of the driving members as described in the first and the second embodiments that they have piezoelectric layer with electric poles as shown in FIG. 2.

Each of the edge portions 2Ba, 2Bb, 2Bc and 2Bd corresponds to the marginal portion of the mirror 2B for the direction of the X-axis, −Y-axis, Y-axis and −X-axis respectively. Each of portions 2ab, 2bd, 2cd and 2ac corresponds to the middle point of the edge portions 2Ba and 2Bb, the middle point of the edge portions 2Bb and 2Bd, the middle point of the edge portions 2Bc and 2Bd, and the middle point of the edge portions 2Ba and 2Bc respectively. A line crossing the edge portion 2Ba and 2Bd corresponds to the X-axis, and another line crossing the edge portion 2Bb and 2Bc corresponds to the Y-axis and the normal line of the mirror 2B corresponds to the Z-axis.

FIG. 10 is a table showing the status of the driving members 25 through 28 when the light is deflected to each point shown in FIG. 3. In case that a light is deflected to the point “1”, a driving status of the driving members 25 and 26 is +1 (expansion), and that of the driving members 27 and 28 is −1 (contraction). The area 21a of the supporting member 21 corresponding to the driving member 25, and the area 22a of the supporting member 22 corresponding to the driving members 26 transform by its front surface becoming convex. The area 23a of the supporting member 23 corresponding to the driving member 27, and the area 24a of the supporting member 28 corresponding to the driving member 28 transform by its rear surface becoming concave.

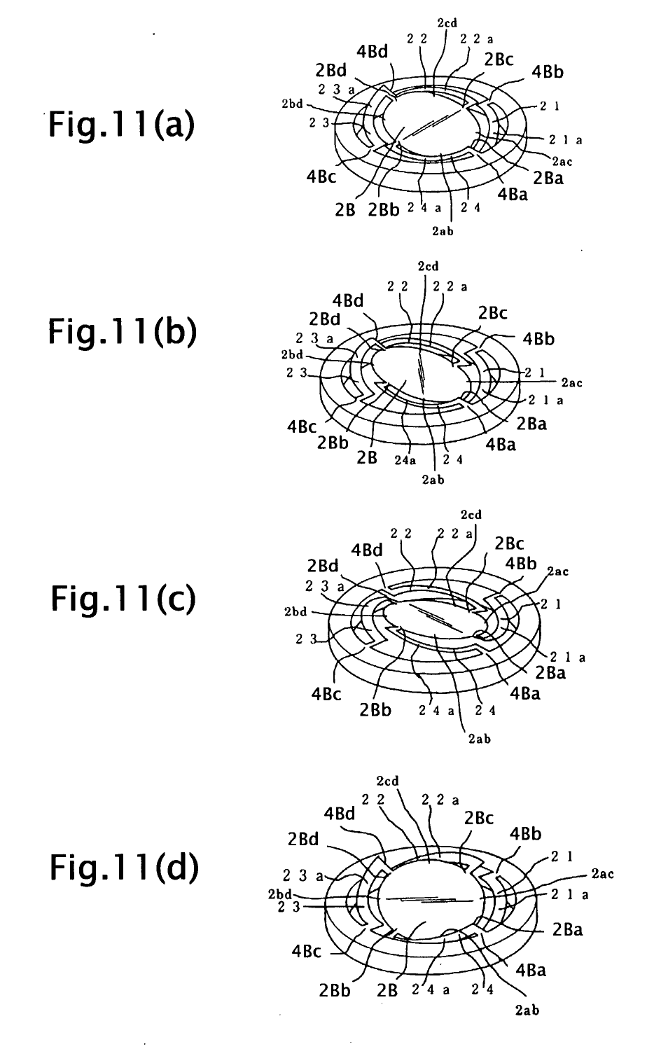

FIGS. 11(a) through 11(d) are perspective view of the light deflector shown in FIG. 9 showing the status of mirror sloping upon the deflection of light. In FIG. 11(a), the edge 2Bd of the mirror 2B becomes highest, and the edge 2Ba becomes a lowest position that the mirror 2B slopes in center of the Y-axis and inclining the reflection side to the +X axis to deflect the light to the point “1”.

In case the light is deflected to the point “2” shown in FIG. 3, the driving status of the driving member 26 is +1 (expansion) and the driving status of the driving member 28 is −1 (contraction). The driving members 25 and 27 do not change (the driving status thereof is “0”). The area 22a of the supporting member 22 corresponding to the driving member 26 transforms its front surface convexly and its rear surface concavely. The area 24a of the supporting member 24 corresponding to the driving member 28 transforms its front surface concavely and its rear surface convenxly.

The areas 21a and 23a of the supporting members 21 and 23 corresponding to each of the driving members 25 and 27 do not transform. Accordingly, as shown in FIG. 11(b), the edge 2bd becomes highest and the edge 2ac becomes the lowest so that the mirror 2B inclines −45 degrees towards the first quadrant. Consequently, the light deflects to the point “2”.

In case that the light is deflected to the point “3” shown in FIG. 3, the driving members 26 and 27 are +1 (expansion) and the driving members 25 and 28 are −1 (contraction). The areas 22a and 23a of the supporting members 22 and 23, which correspond to the driving members 26 and 27 respectively, transform its front surface convexly and its rear surface concavely. The area 21a and 24a of the supporting members 21 and 24, which correspond to the driving members 25 and 28 respectively, transform its front surface convexly and its rear surface concavely. Accordingly, the edge 2Bb of the mirror 2B becomes the highest and the edge 2Bc of the mirror 2B becomes the lowest so that the mirror 2B rotates in center of the X-axis to incline the reflection side to the direction of +Y-axis. Consequently, the light deflects to the point “3” shown in FIG. 3.

Correspondingly, the driving member 25 is +1 (expansion), the driving member 27 is −1 (contraction), and the driving members 26 and 28 is “0”(initial condition). The area 21a of the supporting member 21 corresponding to the driving member 25 transforms its front surface convexly and its rear surface concavely. The area 23a of the supporting member 23 corresponding to the driving member 27 transforms its front surface convexly and its rear surface concavely.

The areas 22a and 24a of the supporting member 22 and 24 corresponding to the driving members 26 and 28 do not transform. Accordingly, the edge of 2cd of the mirror 2B becomes the highest and the edge 2ab of the mirror 2B becomes the lowest so that the mirror 2B rotates +45 degrees towards the direction of the fourth quadrant. Consequently, the light deflects to the point “8” shown in FIG. 3.

The light deflection to the other direction can be conducted by controlling the driving members 25, 26, 27 and 28 as described above.

The light deflector 20 in accordance with the third embodiment is composed of four supporting members 21 through 24 along the circumference of the mirror 2B to hold itself. The supporting members 21 through 24 have driving members 25 though 28 composed of piezoelectric material. The supporting members 21 through 24 can be formed longer enough in the small area so that the mirror 2B can widely be sloped with smaller driving energy. Accordingly, there provides highly efficient light deflector.

The driving members 25 through 28 are described as having piezoelectric material but they are not limited to such the materials as explained above.

[Fourth embodiment]

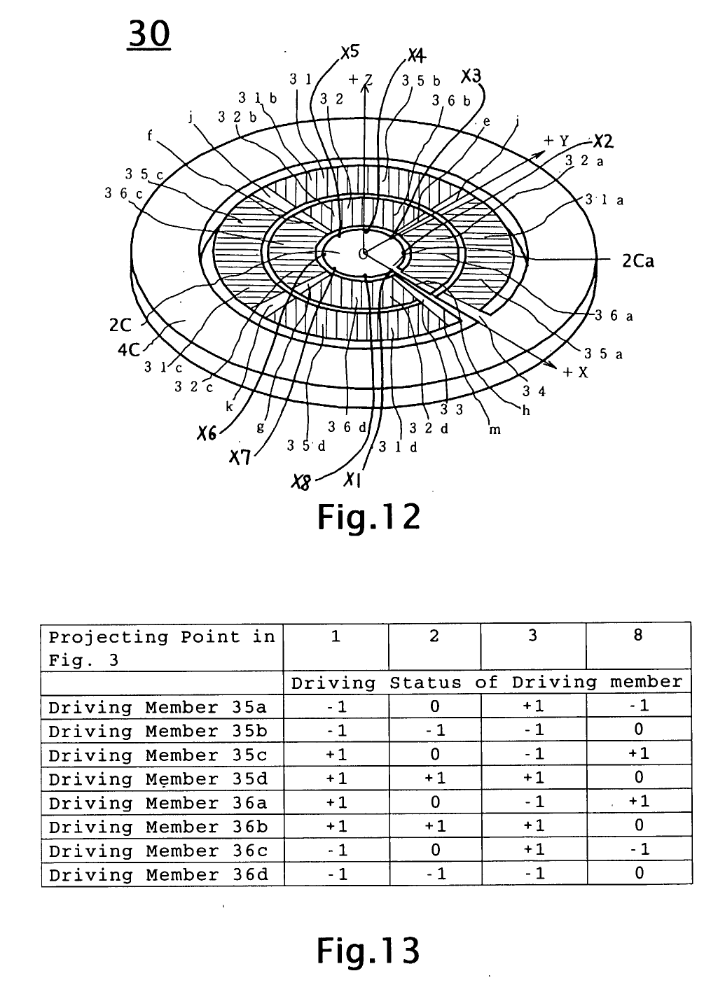

FIG. 12 shows a perspective view of a light deflector in accordance with a fourth embodiment of the present invention. In FIG. 12, a light deflector 30 is composed of discoid mirror 2C, a supporting member 31 and 32, and a frame member 4C. The supporting members 31 and 32 are formed in concentric circle of the mirror 2C that one edge of the supporting member 31 is connected with frame member 4C by a connecting portion 34, and another edge of the supporting member 31 is connected with the supporting member 32 by a connecting portion 33. The other edge of the supporting member 32 is connected with the mirror 2C by a connecting portion 2Ca. The supporting members 31 and 32 are all in the same plane with the mirror 2C and the frame 4C.

A line crossing the center “0” of the mirror 2C and the edge portion 2Ca of the mirror 2Ca represents the X-axis, a line crossing the center “0” and orthogonal to the X-axis represents the Y-axis. A line crossing the center “0” and orthogonal to both the X and Y axes represents the Z-axis. In FIG. 12, the Y and Z axes are shown as +Y axis and +Z axis. An area 31a of the supporting member 31, which is divided by the X and Y axes corresponding to the first quadrant thereof, has a driving member 35a. An area 32a of the supporting member 32, which is divided by the X and Y axes corresponding to the first quadrant thereof, has a driving member 36a. Similarly, an area 31b corresponding to the second quadrant of the supporting member 31 is having a driving member 35b, and an area 32b of supporting 32 has a driving member 36b. An area 31c corresponding to the third quadrant of the supporting member 31 has a driving member 35c, and an area 32c of supporting member 32 has a driving member 36c. An area 31d corresponding to the fourth quadrant of the supporting member 31 has a driving member 35d; and an area 36d of supporting member 32 has a driving member 36d.

Further to FIG. 12, the portion of the supporting member 31 crossing the +X axis is “m” and the −X axis is “j”, and crossing the +Y axis is “i” and the −Y axis is “k”. The portion of the supporting member 32 crossing the +X axis is “h” and the −X axis is “f”, and crossing the +Y axis is “e” and the −Y axis is “g”.

The driving members 35a through 35d and 36a through 36d have a structure shown in FIG. 2 and the wiring not shown is placed along the supporting members 31 and 32.

In FIG. 12, a point X1 is a cross-point of +X axis with the circumference of the mirror 2C. Each point rotated in every 45 degrees to anti-clockwise will be X2, X3 and X4 through X8 and they correspond to the direction of the projecting points shown in FIG. 3.

FIG. 13 is a table showing a driving status of the driving members 35a through 35d and 36a through 36d.

In case that the light is deflected from the center “0” to the point 1, as shown in FIG. 13, the driving members 35a and 35b are −1 (contraction) respectively and the driving members 35c and 35d are +1 (expansion) respectively. Further, the driving members 36a and 36b are +1 (expansion) and the driving members 36c and 36d are −1 (contraction) respectively. The driving members transforming to expand (+1) are having its front surface convex and its rear surface concave. Contrary, the driving members transforming to contract (−1 ) are having its front surface concave and its rear surface convex.

In this sense, the driving members 35a and 35b, 36c and 36d have a concave front surface and a convex rear surface, and the driving members 35c and 35d, 36a and 36b have a convex front surface and a concave rear surface.

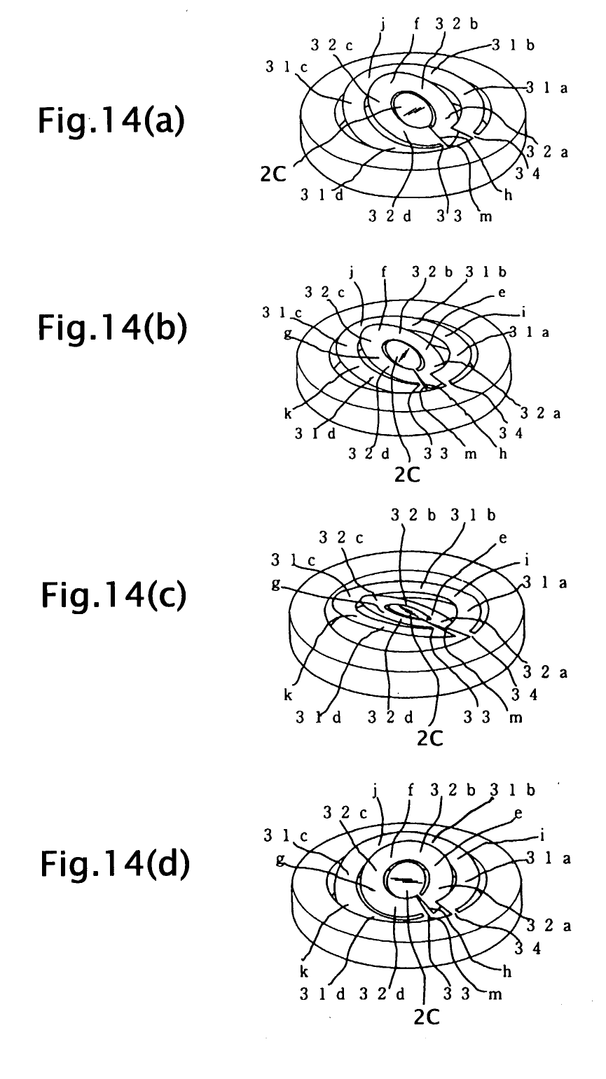

FIGS. 14(a) through 14(d) are perspective view of the light deflector shown in FIG. 12 according to the fourth embodiment of the present invention. Some of the reference numbers in FIG. 12 have been omitted from FIGS. 14(a) through 14(d) in order to avoid an illegible diagram with crowded reference numbers.

In FIG. 14(a), the mirror 2C rotates in the center of the Y-axis and inclines the reflection side of the mirror 2C towards the direction of the +X axis (i.e. the point X5 shown in FIG. 12 becomes highest and the point X1 becomes lowest), and the light deflects to the point “1” shown in FIG. 3.

In case that the light is deflected from the center “0” to the point “2”, the driving member 35b is −1 (contraction) and the driving members 35d is +1 (expansion) while the driving members 35a and 35c do not change. Further, the driving members 36b is +1 (expansion) and the driving members 36d is −1 (contraction) while the driving members 36a and 36c do not change. As the driving members 35a, 35c, 36a, 36c do not change, the areas 31a, 31c, 32a, 36c do not transform.

The driving members transforming to expand (+1) are having a convex surface and a concave rear surface. Contrary, the driving members transforming to contract (−1 ) are having a concave surface and a concave rear surface. Accordingly, in FIG. 14(b), the mirror 2C will rotate at the center of −45 degrees axis of the X-Y coordinate (i.e. the point X6 shown in FIG. 12 becomes highest and the point X2 becomes lowest), and the light deflects to the point “2” shown in FIG. 3.

In case that the light is deflected from the center “0” to the point “3”, the driving members 35a, 35d, 36b and 36c are +1 (expansion) and the driving members 35b, 35c, 36a, 36d are −1 (contraction) respectively. The driving members transforming to expand (+1) are having a convex surface and a concave rear surface. Contrary, the driving members transforming to contract (−1 ) are having a concave surface and a convex rear surface. Accordingly, in FIG. 14(c), the mirror 2C will rotate at the center of the X-axis (i.e. the point X7 shown in FIG. 12 becomes highest and the point X3 becomes lowest), and the light deflects to the point “3” shown in FIG. 3.

In case that the light is deflected from the center “0” to the point “8”, the driving members 35a and 36c are −1 (contraction) and the driving members 35c and 36a are +1 (expansion) respectively while the driving members 35b, 35d, 36b and 36d do not change.

The driving members transforming to expand (+1) are having a convex surface and a concave rear surface. Contrary, the driving members transforming to contract (−1 ) are having a concave surface and a convex rear surface. Accordingly, in FIG. 14(b), the mirror 2C rotates at the center of +45° axis of the X-Y coordinate (i.e. the point X4 shown in FIG. 12 becomes highest and the point X8 becomes lowest), and the light deflects to the point “8” shown in FIG. 3.

The driving members in the position opposed to each other along the circumference of the mirror 2C are supplied with impressed voltage of “0” or in an inverted polarity, or have equal absolute value. For example, the driving members 35a and 35c are provided with impressed voltage having equal absolute value or “0”. Similarly, each of the pair of driving members 36a and 36c, the pair of driving members 35b and 35d and the pair of driving members 36d and 36b are provided with impressed voltage which are equal absolute value or are “0”. In addition, the plurality of driving members 35a and 36a, 35b and 36b, 35c and 36c, 35d and 36d in the same divided areas are supplied with impressed voltage of “0” or in an inverted polarity (or having equal absolute value). Otherwise, the mirror 2C may rotate with translational movement towards the Z-axis and does not stably rotate to provide proper deflection of the light.

As described above, the light deflector in accordance with the fourth embodiment of the present invention has supporting members 31 and 32 connected serially along the circumference of the mirror 2C around 360 degrees to hold itself and has the driving members 35a through 35d and 36a through 36d which transform towards the direction of the Z-axis in each quarter area divided in the center of the mirror 2C.

The movement of the mirror 2C does not stress the mirror 2C itself because the mirror 2C moves along with the slope of the supporting members connected in one. Accordingly, the plane surface of the mirror 2C is maintained and stable change of the light path can be obtained so that a highly efficient light deflector 30 is provided.

As the supporting members are connected in one to be longer than the supporting member described in the first embodiment, the slope angle of the mirror can be bigger than that of the first embodiment.

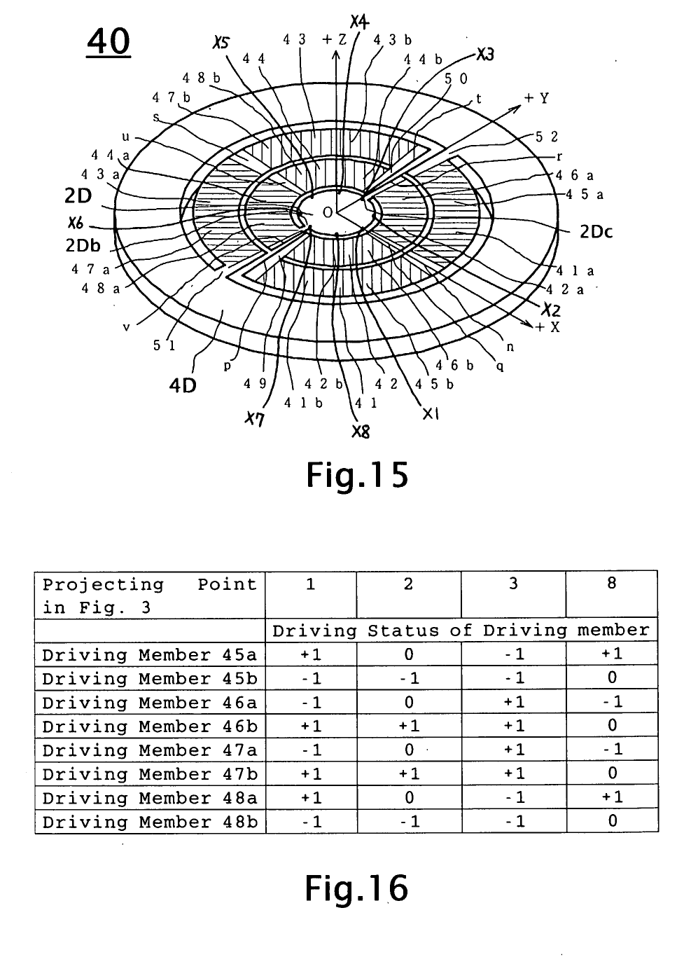

The driving members 35a through 35d and 36a through 36d in the fourth embodiment are described as piezoelectric material but it is not limited to such material as long as they provide transformation to slope the mirror for deflection.

[Fifth embodiment]FIG. 15 is a perspective view of a light deflector 40 in accordance with a fifth embodiment of the present invention. In FIG. 15, a light deflector 40 is composed of a mirror 2D, a supporting member 41 through 44 and a frame portion 4D. The supporting members 41 through 44 are in a half circle shape of the concentric circle and positioned in the same plane with the mirror 2D. One edge “r” of the supporting member 42 is connected with an edge 2Dc of the mirror 2D and another edge “p”of the supporting member 42 is connected with the supporting member 41 through a connecting portion 49. Further, the other edge of the supporting member 41 is connected with the frame portion 4D through a connecting portion 52. One edge “v” of the supporting member 44 is connected with an edge 2Db of the mirror 2D and another edge “t” of the supporting member 43 is connected with the supporting member 41 through a connecting portion 50. Furthermore, the other edge of the supporting member 43 is connected with the frame portion 4D through a connecting portion 51.

The supporting member 41 has a mid portion “n” and the supporting member 42 has a mid portion “q”. The supporting member 43 has a mid portion “s” and the supporting member 44 has a mid portion “u”.

In FIG. 15, a line crossing the edge 2Db and 2Dc is the Y-axis. A line orthogonal to the Y-axis is the X-axis and a line orthogonal to both the X-axis and Y-axis is the Z-axis. The area divided by the X-axis and Y-axis forms the first quadrant (+X and +Y axes portion), the second quadrant (−X and +Y axes), the third quadrant (−X and −Y axes) and the fourth quadrant (+x and −Y axes).

An area 41a of the supporting member 41 corresponding to the first quadrant has a driving member 45a, an area 42a of the supporting member 42 corresponding to the first quadrant has a driving member 46a.

An area 41b of the supporting member 41 corresponding to the fourth quadrant has a driving member 45b, an area 42b of the supporting member 42 corresponding to the fourth quadrant has a driving member 46b.

An area 43a of the supporting member 43 corresponding to the third quadrant has a driving member 47a, an area 44a of the supporting member 44 corresponding to the third quadrant has a driving member 48a.

An area 43b of the supporting member 43 corresponding to the second quadrant has a driving member 47b, an area 44b of the supporting member 44 corresponding to the second quadrant has a driving member 48b.

The driving members 45a, 45b, 46a, 46b, 47a, 47b, 48a and 48b include piezoelectric material and a wiring not shown for supplying power to the driving members is placed along the supporting member 41 through 44 respectively.

For explanation purpose, the cross-point of the outer circumference of the mirror 2D and the X-axis is point X1. Each point rotating 45 degrees from X1 at the center “0” of the mirror 2D is indicated as point X2, point X3, point X4, point X5, point X6, point X7 and point X8. These points correspond to the direction of projection described in FIG. 3.

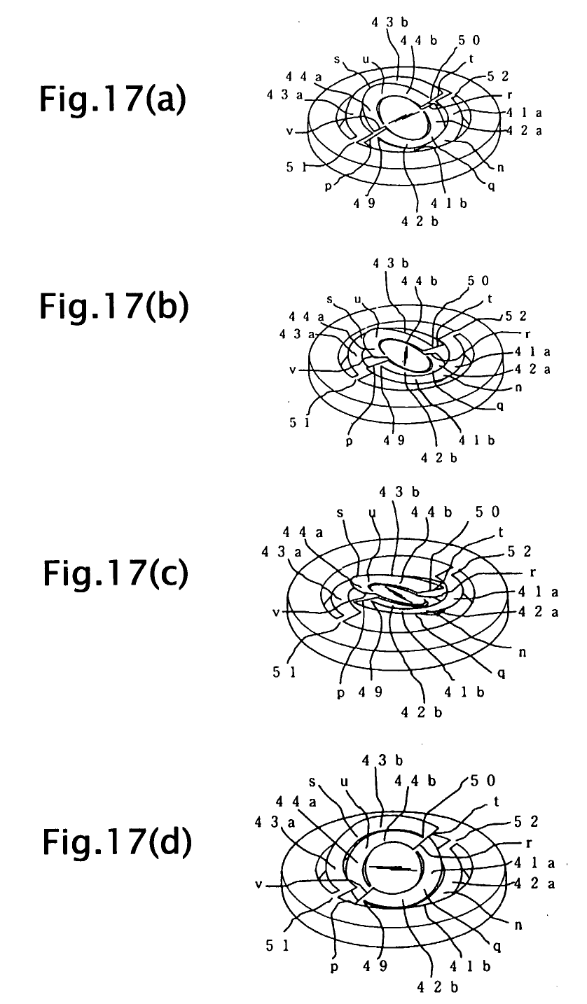

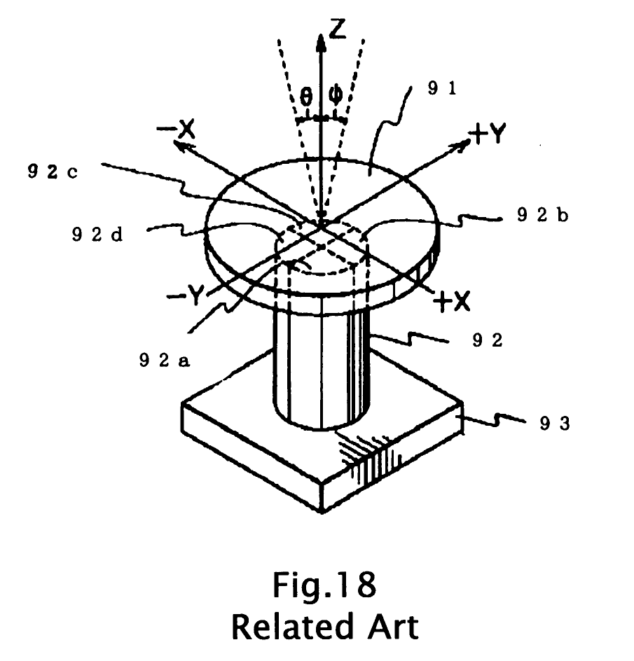

FIG. 16 is a table showing a driving status of the driving members 45a, 45b, 46a, 46b, 47a, 47b, 48a and 48b and FIG. 17(a) through 17(d) are perspective view of the light deflector 40 in accordance with the driving status shown in FIG. 16. The coordinate axes in each of FIG. 3, FIG. 15 and FIG. 17 correspond to each other. In FIGS. 17(a) through 17(d), some reference numbers indicated in FIG. 15 are omitted in order to avoid illegibility.

In case that the light deflector 40 deflects light to the point 1 from the point 0 shown in FIG. 3, the driving members 45a, 46b, 47b and 48a are +1 (expansion) respectively that the areas corresponding to such the driving members have its front surface convex and its rear surface concave. The driving members 45b, 46a, 47a and 48b are −1 (contraction) respectively that the areas corresponding to such the driving members have its front surface concave and its rear surface convex.

Accordingly, the mirror 2D will slope as shown in FIG. 17(a) that the point X5 moves to the highest position while the point X1 moves to the lowest of which mirror 2D rotates at the center of Y axis and inclines towards the direction of the +X axis, and eventually, the light deflects towards the point 1 in FIG. 3.

In case that the light deflector 40 deflects light to the point 2 from the point 0 shown in FIG. 3, the driving members 45b and 48b are −1 (contraction) that the corresponding areas 41b and 44b have its front surface concave and its rear surface convex. The driving members 46b and 47b are +1 (expansion) that the corresponding areas 42b and 43b have its front surface convex and its rear surface concave. The driving members 45a, 46a, 47a and 48a do not change that the corresponding areas 41a, 42a, 43a and 44a do not transform.

Accordingly, the mirror 2D slopes with the point X6 in the highest position and the point X2 in the lowest position so that the mirror 2D incline −45 degrees towards the X and Y axes (the first quadrant) and that the light deflects to the point 2 from the point 0.

In case that the light deflector 40 deflects light to the point 3 from the point 0 shown in FIG. 3, the driving members 45a, 45b, 48a and 48b are −1 (contraction) respectively that the corresponding areas 41a, 41b, 44a and 44b have its front surface concave and its rear surface convex. The driving members 46a, 46b, 47a and 47b are +1 (expansion) respectively that the corresponding areas 42a, 42b, 43a and 43b have its front surface convex and its rear surface concave.

Accordingly, the mirror 2D slopes with the point X7 in the highest position and the point X3 in the lowest position so that the mirror 2D inclines towards the direction of +Y and rotates at the center of the X-axis. Consequently, the light deflects to the point 3 from the point 0.

In case that the light deflector 40 deflects light to the point 8 from the point 0 shown in FIG. 3, the driving members 45a and 48a are +1 (expansion) respectively that the corresponding areas 41a and 44a have its front surface convex and its rear surface concave. The driving members 46a and 47a are −1 (contraction) respectively that the corresponding areas 42a and 43a have its front surface concave and its rear surface convex. The driving members 45b, 46b, 47b and 48b do not change that the corresponding areas 41b, 42b, 43b and 44b do not transform.

Accordingly, the mirror 2D slopes with the point X4 in the highest position and the point X8 in the lowest position so that the mirror 2D inclines towards the direction of +45 degrees axis in the X-Y coordinates and rotates towards the fourth quadrant to deflects the light to the point 8.

As described above, the light deflector in accordance with the fifth embodiment of the present invention is composed of the supporting member 41 through 44 in concentric circle of the mirror 2D. The mirror 2D is held by substantially two supporting members that the mirror will rotates without a stress. Accordingly, the plane surface of the mirror 2D is maintained and stable change of the light path can be obtained so that a highly efficient light deflector 40 is provided.

As the length of the supporting member can substantially be longer than the second embodiment, the fifth embodiment can obtain even more bigger slope angle compared to the second embodiment. The driving members 35a through 35d and 36a through 36d in the fourth embodiment are described as being made of piezoelectric material but it is not limited to such material as long as they provide convex-concave transformation to slope the mirror for deflection.

The light deflector in accordance with the present invention can be produced by applying micromachined technology so that it can be constructed on a single wafer in matrix arrangement. Accordingly, the light deflector is suitable for cross-connect optical switches for switching plurality of optical fiber for optical communication.

As described above, the light deflector is composed of the supporting member for holding the mirror and the driving member placed in the supporting member, which transforms to become convex-concave to rotate the mirror by sloping of the supporting member, so that the mirror can be stably deflects light without a stress.

As the light deflector in accordance with the present invention can be produced by applying micromachined technology, it can be constructed compact in size, and plurality of the light deflector can be produced on cross-connect switch for optical communication.

Further, the light deflector can be controlled stably by supplying electric power with inverted polarity or having the same absolute value.

It is to be understood that the invention is not limited in its application to the details of construction and arrangement of parts illustrated in the accompanying drawings, since the invention is capable of other embodiments and of being practiced or carried out in various ways. Also it is to be understood that the phraseology or terminology employed herein is for the purpose of description and not of limitation.

What is claimed is:

1. A light deflector for deflecting light to switch a plurality of cross-connected optical fibers for optical communication, comprising:
a mirror for deflecting light input through the plurality of cross-connected optical fibers by sloping at the center thereof;
a supporting member for holding the mirror in the same plane, wherein the supporting member is connected with the mirror at least one edge thereof;
a frame portion for holding another edge of the supporting member; and
a driving member incorporated in the supporting member for inclining the supporting member by transforming convex-concave to make the mirror sloping to desirable direction.

2. The light deflector as claimed in claim 1, wherein the driving member is placed in each of four quadrant areas divided by two lines orthogonal to each other, which at least cross the center of the mirror and a connecting portion of the mirror with the supporting member.

3. The light deflector as claimed in claim 1, wherein a single piece of the supporting member is placed along the outer frame of the mirror in 360 degrees.

4. The light deflector as claimed in claim 1, wherein two pieces of the supporting member are respectively placed along the outer frame of the mirror in 180 degrees.

5. The light deflector as claimed in claim 1, wherein a plurality of supporting members having a different radius of concentric circle of the mirror, is connected with each other by an edge contiguous to each supporting member to form a single piece.

6. The light deflector as claimed in claim 1, wherein the driving member placed symmetric with respect to the center of the mirror is controlled by supplying with an impressed voltage of zero and over values having inverted polarity compared to initial condition.

7. The light deflector as claimed in claim 6, wherein the plurality of driving members placed in the same area symmetric with respect to the center of the mirror is further controlled by supplying with an impressed voltage of zero and over values having inverted polarity compared to initial condition.

8. A method for driving a light deflector for use in switching a plurality of cross-connected optical fibers for optical communication, comprising:
a mirror for deflecting light input through the plurality of cross-connected optical fibers by sloping at the center thereof;
a supporting member for holding the mirror in the same plane, wherein the supporting member is connected with the mirror at least one edge thereof;
a frame portion for holding another edge of the supporting member; and
a driving member incorporated in the supporting member for inclining the supporting member by transforming convex-concave to make the mirror sloping to desirable direction,
the method comprising steps of:
holding the mirror for light deflection by the supporting member being connected with the mirror at least one edge thereof and the other edge with a frame portion;
driving the driving member incorporated in the supporting member by supplying an impressed voltage to make the driving member transforming convex-concave to slope the mirror, wherein the impressed voltage is having zero and over values of inverted polarity compared to initial condition; and
deflecting an input light through the optical fiber by the sloping of the mirror to a desirable direction.

9. The method for driving the light deflector as claimed in claim 8, wherein the plurality of driving members placed in the same area symmetric with respect to the center of the mirror is further controlled by supplying with an impressed voltage of zero and over values having inverted polarity compared to initial condition.
